(19) United States
(12) Patent Application Publication
(10) Pub. No.: US 2019/0091956 A1
(43) Pub. Date: Mar. 28, 2019

(54) PNEUMATIC TIRE AND METHOD FOR MANUFACTURE THEREOF

(71) Applicant: TOYO TIRE & RUBBER CO., LTD., Itami-shi (JP)

(72) Inventor: Toru Yokoyama, Itami-shi (JP)

(73) Assignee: TOYO TIRE & RUBBER CO., LTD., Itami-shi (JP)

(21) Appl. No.: 16/121,944

(22) Filed: Sep. 5, 2018

(30) Foreign Application Priority Data
Sep. 25, 2017 (JP) 2017-183681

(51) Int. Cl. B29D 30/60; B29D 30/30; B60C 11/00; B60C 13/02

(52) U.S. Cl. CPC B29D 30/60; B29D 30/3028; B29D 2030/383; B60C 13/02; B60C 11/005

(57) ABSTRACT

A tire having a rubber member formed by winding a ribbon rubber in uninterrupted fashion about a rotational axis of the tire. The rubber member has a parallel portion at which the ribbon rubber is parallel to a tire circumferential direction at an end toward an exterior in a tire width direction, and an inclined portion at which the ribbon rubber is inclined with respect to the tire circumferential direction in such fashion as to cause the ribbon rubber to be directed from the parallel portion toward an interior in the tire width direction. The ribbon rubber from which the parallel portion is formed is wound in the tire circumferential direction for a wrap angle of not 360° but N ° (N=210 to 300).

### BACKGROUND OF THE INVENTION

### Field of the Invention

The present disclosure relates to a pneumatic tire having a rubber member formed from wound ribbon rubber, and to a method for manufacture thereof.

### Description of the Related Art

What is referred to as a ribbon winding process has conventionally been proposed in which a rubber member (e.g., cap rubber) making up a tire is formed by causing unvulcanized ribbon rubber to be wound about the rotational axis of the tire so as to wrap around the outside circumferential surface of a more or less cylindrical rotating support body such that the side edges thereof form multiple layers. Known among ribbon winding processes are those which are said to employ the inclined winding technique and those which are said to employ the pitch-fed winding technique.

The inclined winding technique is disclosed at FIG. 4 of Japanese Patent Application Publication Kokai No. 2002-178415 and at FIG. 8 of Japanese Patent Application Publication Kokai No. 2006-69130. When ribbon rubber is wound from a start point to a finish point at such orientation as to cause it to be inclined with respect to the tire circumferential direction, this results in production of blank regions where no ribbon rubber is wound at either end in the tire width direction. Presence of regions where no rubber is present is not preferred, because it will produce differences in the cross-sectional structure of the tire. Production of blank regions where no rubber is present is therefore avoided by causing the ribbon rubber to be wound so as to be parallel to the tire circumferential direction for one full revolution at portions corresponding to the ends in the tire width direction. However, as shown in FIG. 11, when the inclined winding technique is employed, this causes a pair of heavy regions H where many portions of ribbon rubber overlap to be produced at diagonally opposed locations of the tire, and causes a pair of light regions L where few portions of ribbon rubber overlap to be produced at diagonally opposed locations of the tire. This type of mass unbalance, which is referred to as dynamic unbalance (couple unbalance), can lead to poor uniformity.

The pitch-fed winding technique is disclosed at FIGS. 1 through 4 and 6 of Japanese Patent Application Publication Kokai No. 2006-69130 and at Japanese Patent Application Publication Kokai No. 2013-111864. In this technique, the ribbon rubber is maintained in such orientation as will cause it to be parallel to the tire circumferential direction, and following winding of one full revolution, the ribbon rubber is shifted in position in the tire width direction with each additional revolution that is wound thereafter. With the pitch-fed winding technique, because the ribbon rubber is wound at such orientation as to cause it to be parallel to the tire circumnferential direction for one full revolution, the foregoing couple unbalance problem does not occur. Instead, because the amount of rubber is greater at only those locations at which the ribbon rubber is shifted in position, only the locations in the tire circumferential direction at which shifting takes place will be heavy. This type of mass unbalance, which is referred to as static unbalance, can lead to poor uniformity. At the foregoing inclined winding technique, note that while couple unbalance occurs, static unbalance does not.

Static unbalance can be easily adjusted by arranging mass(es) at location(s) 180° on the opposite side therefrom in the tire circumferential direction, but adjustment of couple unbalance is difficult.

### SUMMARY OF INVENTION

The present disclosure was conceived in view of such problem, it being an object thereof to provide a pneumatic tire having reduced mass unbalance in the context of a tire having a structure in accordance with what is referred to as the inclined winding technique, and a method for manufacture thereof.

To solve the foregoing problem, the present disclosure employs means as described below.

In other words, according to the present disclosure, there is provided a pneumatic tire having:

a rubber member formed by winding a ribbon rubber in uninterrupted fashion about a rotational axis of the tire;

wherein the rubber member has a parallel portion at which the ribbon rubber is parallel to a tire circumferential direction at an end toward an exterior in a tire width direction, and an inclined portion at which the ribbon rubber is inclined with respect to the tire circumferential direction in such fashion as to cause the ribbon rubber to be directed from the parallel portion toward an interior in the tire width direction; and

wherein the ribbon rubber from which the parallel portion is formed is wound in the tire circumferential direction for a wrap angle of not 360° but N ° (N=210 to 300).

In forming parallel portion, by thus causing ribbon rubber to be wound for a wrap angle of not 360° but N ° (N=210 to 300) in the tire circumferential direction, it is possible to reduce circumferential mass unbalance as compared with the conventional situation in which the wrap angle of the ribbon rubber thereat is 360°.

### BRIEF DESCRIPTION OF DRAWINGS

FIG. 1 Drawing of tire meridional section showing a pneumatic tire associated with an embodiment of the present disclosure.

FIG. 2 Drawing showing manufacturing facility used in an operation for forming a rubber member.

FIG. 3 Schematic sectional view of ribbon rubber.

FIG. 4 Conceptual diagram showing locus of motion of position at which winding of ribbon for inner liner rubber is carried out.

FIG. 5 Conceptual diagram showing locus of motion of position at which winding of ribbon for cap rubber is carried out.

FIG. 6 Plan view showing course of winding of ribbon rubber.

FIG. 7 Drawing to assist in description that shows, in schematic fashion as it would exist if unwrapped so as to lie in a single plane, the situation that exists when ribbon rubber is wound.

FIG. 8 Drawing to assist in description that shows, in schematic fashion in a circumferential sectional view, the situation that exists when ribbon rubber is wound.

FIG. 9 Drawing to assist in description that shows, in schematic fashion as it would exist if unwrapped so as to lie in a single plane, the situation that exists when ribbon rubber is wound.

FIG. 10 Plan view showing course of winding of ribbon rubber in accordance with another embodiment.

FIG. 11 Drawing to assist in description related to couple unbalance.

### DETAILED DESCRIPTION OF THE PREFERRED EMBODIMENTS

Below, embodiments of the present disclosure are described with reference to the drawings. Description will first be given with respect to the constitution of a pneumatic tire in accordance with the present disclosure, followed by description of a method for manufacturing a pneumatic tire associated with the present disclosure.

### Constitution of Pneumatic Tire

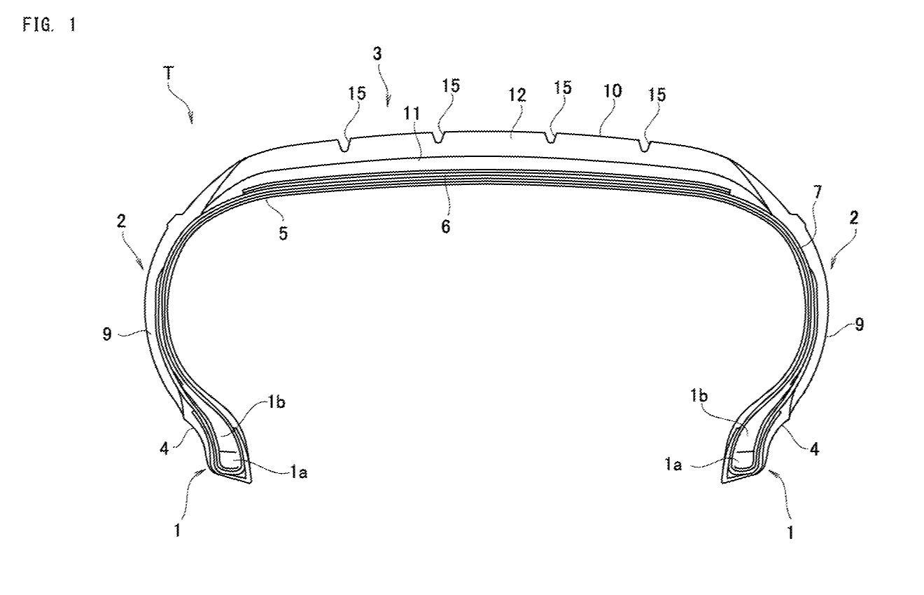

Pneumatic tire T shown in FIG. 1 is provided with a pair of bead regions 1, sidewall regions 2 which extend toward the exterior in the tire radial direction from those respective bead regions 1, and a tread region 3 which is contiguous with the respective outer ends in the tire radial direction of those sidewall regions 2. Arranged at bead region 1 are annular bead core 1a at which steel wire or other such convergent body is coated with rubber, and bead filler 1b which comprises hard rubber.

Arranged between the pair of bead regions 1 is a toroidal carcass layer 7, the ends of which are routed by way of bead cores 1a to be retained in upturned fashion. Carcass layer 7 is made up of at least one (two in the present embodiment) carcass ply, said carcass ply or plies being formed from cord(s) that extend at angle(s) of approximately 90° with respect to the tire circumferential direction and that are coated with topping rubber. Arranged at the inside circumferential surface of carcass layer 7 is—inner liner rubber 5 for retention of air pressure.

At bead region 1, provided at a location toward the exterior from carcass layer 7 is rim strip rubber 4 which comes in contact with the rim when the tire is mounted on a rim (not shown). Furthermore, at sidewall region 2, provided at a location toward the exterior from carcass layer 7 is sidewall rubber 9.

At tread region 3, arranged at a location toward the exterior from carcass layer 7 is belt layer 6 which is made up of a plurality of (two in the present embodiment) belt plies. The respective belt plies are formed from cord(s) that extend in inclined fashion with respect to the tire circumferential direction and that are coated with topping rubber, these being laminated together in such fashion that said cords of neighboring plies intersect with mutually opposite inclinations.

At tread region 3, tread rubber 10 is provided at a location toward the outside circumferential surface from belt layer 6. Tread rubber 10 has cap rubber 12 which makes up the contact patch, and base rubber 11 which is provided at a location toward the interior in the tire radial direction from cap rubber 12. Base rubber 11 comprises rubber of a different type than that at cap rubber 12.

As examples of the aforementioned rubber raw material, natural rubber, styrene-butadiene rubber (SBR), butadiene rubber (BR), isoprene rubber (IR), butyl rubber (HR), and so forth may be cited, it being possible for any one of these to be used alone, or for any two or more of these to be used in combination. Such rubber raw material may have vulcanizing agent(s) and/or vulcanization accelerator(s), plasticizer(s), antioxidant(s), and/or the like blended thereinto as appropriate.

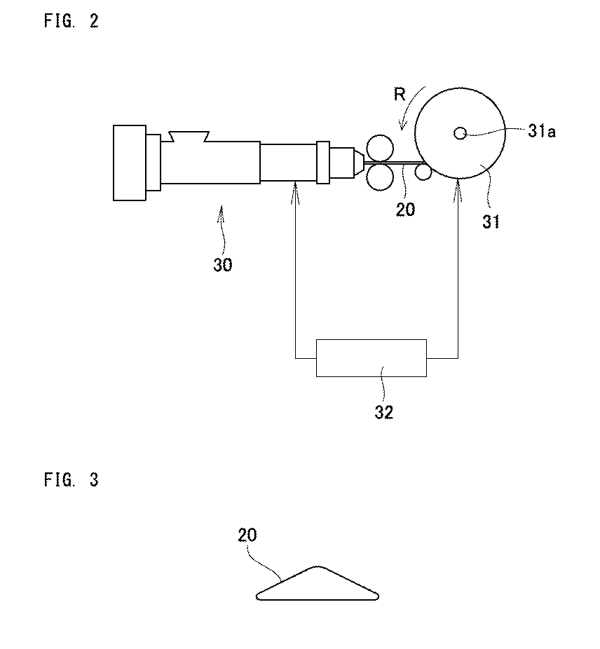

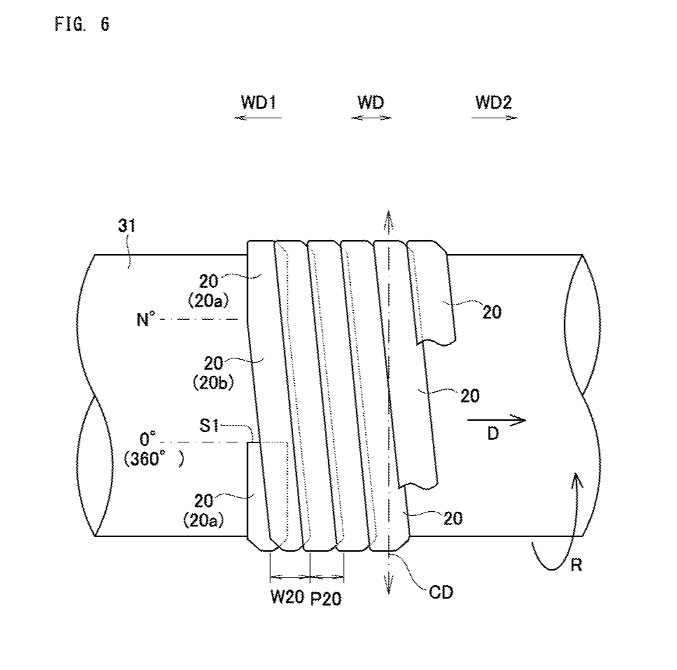

At least one of the plurality of rubber members which make up the tire is formed by means of what is called the ribbon winding process. The ribbon winding process is a process in which the small-width unvulcanized ribbon rubber 20 shown in FIG. 3 is wound about the rotational axis of the tire (see FIG. 2 and FIG. 6) to form a rubber member having a desired cross-sectional shape. As rubber members capable of being formed by means of the ribbon winding process, inner liner rubber 5, tread rubber 10 (cap rubber 12 and base rubber 11), sidewall rubber 9, rim strip rubber 4, and so forth may be cited as examples. All of these rubber members may be formed by means of the ribbon winding process, or any portion of these rubber members may be formed by means of the ribbon winding process, it being possible to carry out appropriate selection with respect thereto.

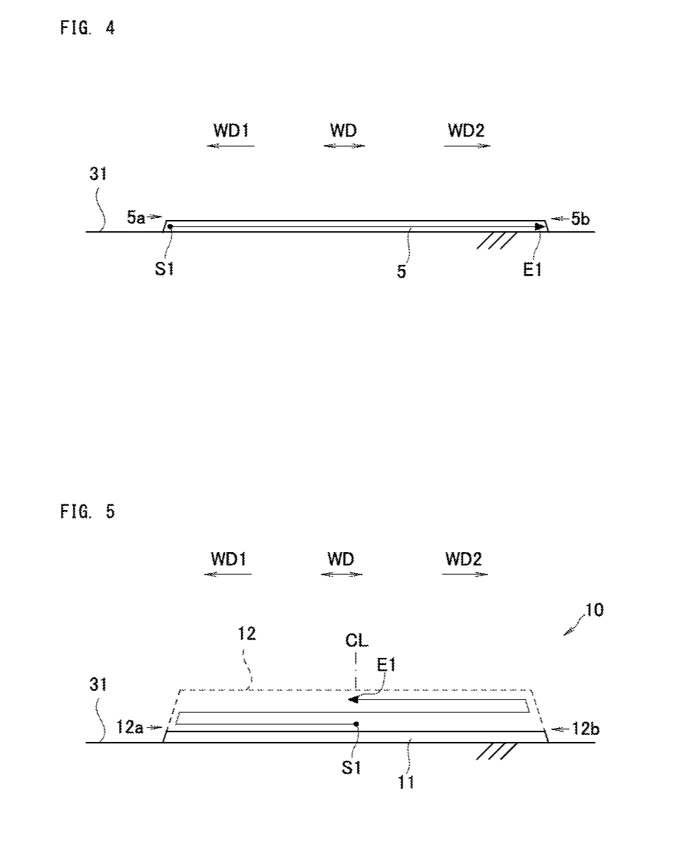

Here, for convenience of description, description will be given in terms of an example in which the ribbon winding process is employed for inner liner rubber 5 and cap rubber 12. As shown in FIGS. 4 and 5, rubber members 5, 12 formed by the ribbon winding process have a winding start point S1 and a winding finish point E1 at ribbon rubber 20 This winding start point S1, this winding finish point E1, and the locus of the motion of the position at which winding is carried out can be seen in a tire meridional section. Detailed description is given below.

Furthermore, at the surface of tread rubber 10, major groove 15 extending in the tire circumferential direction is formed as a result of vulcanization. The tire mold used to carry out vulcanization is provided with protrusion(s), major groove(s) 15 being formed as a result of the fact that said protrusion(s) are pressed into tread rubber 10. While not shown in the drawings, lateral groove(s) and so forth which extend in direction(s) intersecting major groove(s) 15 may be provided as appropriate at tread rubber 10.

### Method for Manufacturing Pneumatic Tire

Next described is a method for manufacturing a pneumatic tire T.

At least one of the plurality of rubber members which make up the tire (e.g., cap rubber 12 and/or inner liner rubber 5) is formed by means of the foregoing ribbon winding process. As shown in FIG. 2, an operation in which rubber members 5, 12 are formed by means of the ribbon winding process comprises an operation in which ribbon rubber 20 supplied from ribbon rubber forming apparatus 30 is wound about rotating support body 31 as rotating support body 31 is made to rotate. The region toward the bottom in FIG. 3 corresponds to the inside circumferential surface which is opposed to rotating support body 31 during winding. While there is no particular limitation with respect to the width and thickness of the ribbon rubber (also referred to as the “rubber strip”), it is preferred that width be 15 mm to 40 mm, and that thickness be 0.5 mm to 3.0 mm.

As shown in FIG. 2, ribbon rubber forming apparatus 30 is constituted so as to be capable of extruding rubber and carrying out forming by means of ribbon rubber 20. Rotating support body 31 is constituted so as to be capable of rotation in the R direction about the axis of shaft 31a and so as to be capable of moving in the direction of the axis of that shaft. Control apparatus 32 controls operations carried out by ribbon rubber forming apparatus 30 and rotating support body 31. While the cross-section of ribbon rubber 20 is triangular in the present embodiment, there is no limitation with respect thereto, there being no objection to employment of ribbon rubber having elliptical, rectangular, or any other such cross-sectional shape. Furthermore, while rotating support body 31 is constituted so as to be capable of moving in the direction of the axis of that shaft, it is also possible to adopt a constitution in which ribbon rubber forming apparatus 30 is made to move relative to rotating support body 31. That is, it is sufficient that the constitution be such as to allow rotating support body 31 to move relative to ribbon rubber forming apparatus 30 in a direction parallel to the axis of that shaft.

As shown in FIG. 6, the pitch P20 at which ribbon rubber 20 is wound is chosen so as to be smaller than the ribbon width W20 of ribbon rubber 20. This makes it possible to cause mutually adjacent coils of ribbon rubber 20, 20 to come in mutual contact when wound in helical fashion thereabout. Arrow D indicates the direction of movement of the position at which winding is carried out, edges of coils of ribbon rubber 20 that are mutually adjacent in this direction being made to mutually overlap. While wound pitch P20 is one-half of ribbon width W20 in the present embodiment, this may be varied as appropriate.

Here, for convenience of description, as seen in a tire meridional section, a first side in the tire width direction WD (the left side in the drawing) will be referred to as WD1, and a second side (the right side in the drawing) which is opposite the first side will be referred to as WD2.

FIG. 4 shows in conceptual fashion the locus of the motion of the position at which winding of ribbon rubber 20 is carried out during an operation in which inner liner rubber 5 is formed. As shown in same drawing, ribbon rubber 20 is wound from start point S1 located at end 5a at first side WD1 in the tire width direction, toward second side WD2 in the tire width direction, to reach finish point E1 located at end 5b at second side WD2 in the tire width direction.

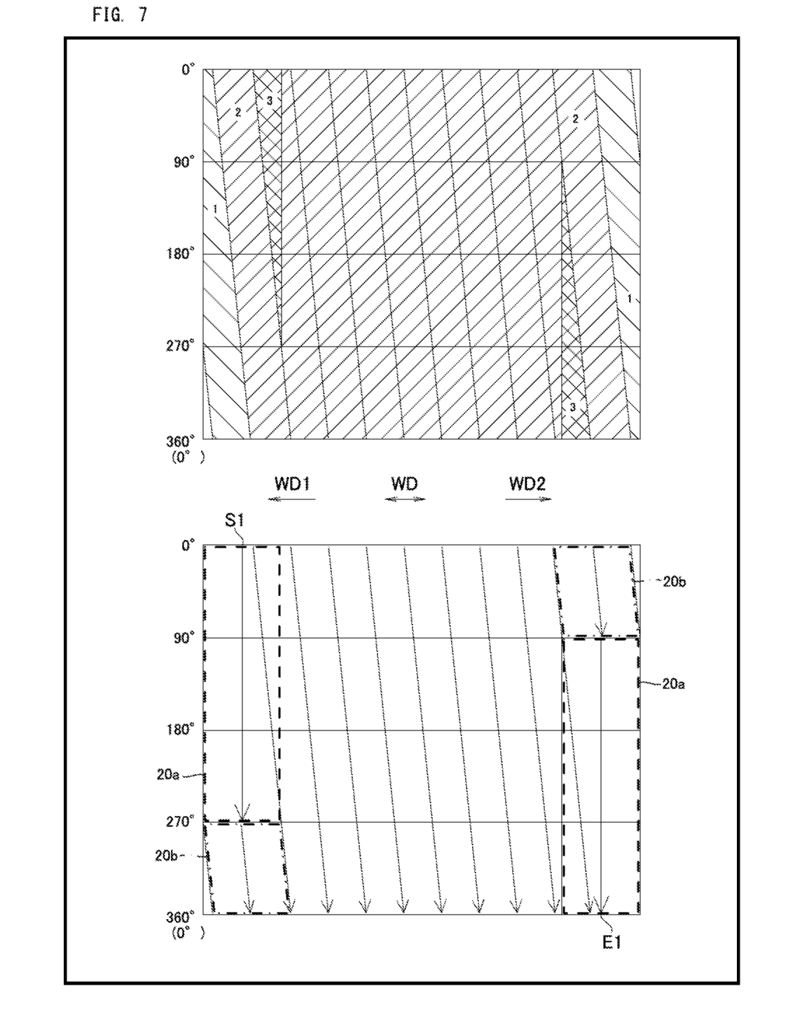

FIG. 7 is a drawing to assist in description that shows, in schematic fashion as it would exist if unwrapped so as to lie in a single plane, the situation that exists when ribbon rubber 20 is wound. Depicted at the upper portion of FIG. 7 is the number of overlapping layers of ribbon rubber 20. At lower left and upper right in same drawing, there are blank regions where ribbon rubber 20 is not wound. There are two layers in the region that occupies the majority of the drawing, there are three layers in some regions, and there are regions where there is one layer.

As shown in FIG. 7 and FIG. 6, winding of ribbon rubber 20 begins at start point S1 located at end 5a at first side WD1 in the tire width direction. The ribbon rubber is wound for a wrap angle of not 360° but N ° (270° in the present embodiment) in the tire circumferential direction CD at such orientation as to cause it to be parallel to the tire circumferential direction CD, as a result of which parallel portion 20a is formed. Ribbon rubber 20 is then wound at such orientation as to cause it to be inclined with respect to the tire circumferential direction CD, as a result of which inclined portion 20b is formed. The ribbon rubber 20 at inclined portion 20b is directed toward the interior in the tire width direction WD from parallel portion 20a. When inclined portion 20b arrives at end 5b at second side WD2 in the tire width direction, the orientation of ribbon rubber 20 is changed so as to cause it to become parallel to the tire circumferential direction CD, parallel portion 20a is wound for a wrap angle of N ° in the tire circumferential direction CD, and winding is finished at finish point E1.

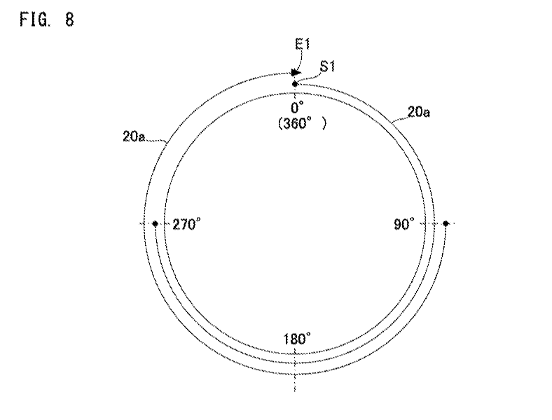

As shown in FIGS. 6 through 8, by causing winding to proceed in such fashion, parallel portion 20a and inclined portion 20b are provided at each of the first side WD1 and the second side WD2 in the tire width direction of a single rubber member. Parallel portion 20a at first side WD1 in the tire width direction extends from 0° to N ° in terms of its location on the tire circumference. Parallel portion 20a at second side WD2 in the tire width direction extends from (360−N; 90 in the present embodiment) ° to 360° in terms of its location on the tire circumference.

While a wrap angle of N=270° was employed in the present embodiment, this may be varied as appropriate within the range N=210 to 300. The reason for saying that N should be within the range 210 to 300 is as follows.

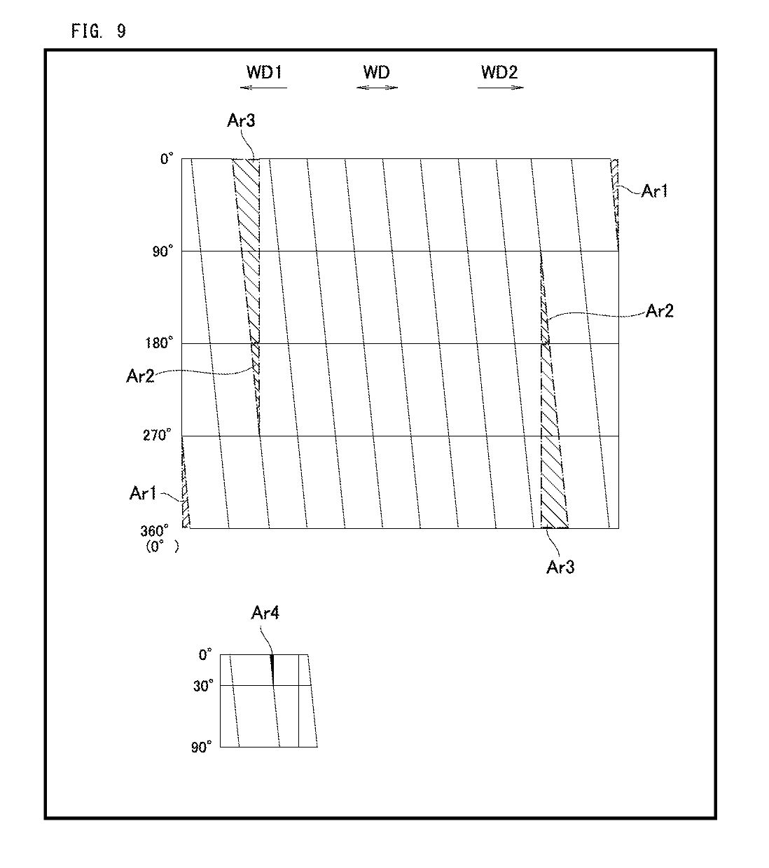

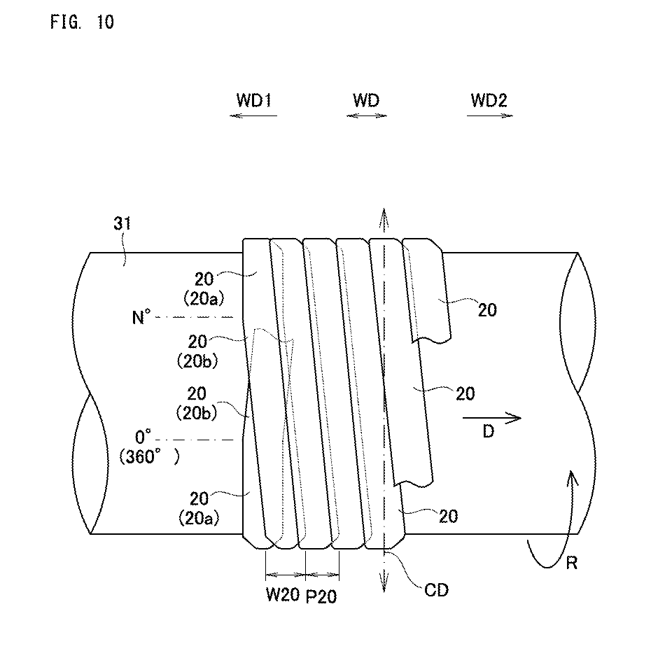

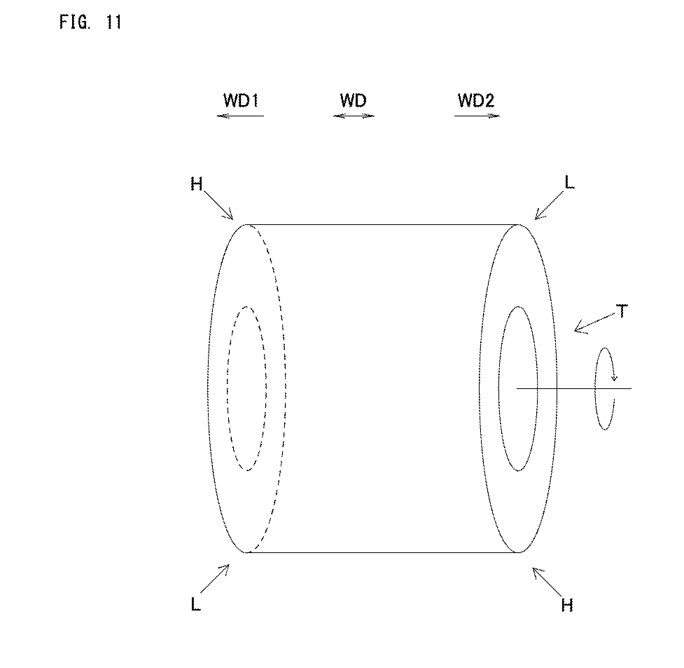

As shown in FIG. 9, because the wrap angle of parallel portion 20a is not 360°, blank regions Ar1 are produced where no ribbon rubber 20 is wound. At first side WD1 in the tire width direction, there are regions Ar2, Ar3 where three layers of ribbon rubber 20 overlap. Here, if this is divided into an upper portion which extends from 0° to 180° in terms of location on the circumference, and a lower portion which extends from 180° to 360° in terms of location on the circumference, because the areas of regions Ar1 and Ar2 are the same, the area in the lower portion will correspond to two layers of Ar2 regions as calculated based on “region Ar2×three layers—Ar1×one layer”. In contradistinction hereto, the area of the upper portion will correspond to three layers of Ar3 regions. If the difference between the areas of regions Ar3 and Ar2 is small, this will reduce the circumferential mass unbalance between the upper region and the lower region. Calculation was therefore carried out to determine the areas of region(s) Ar2 and region(s) Ar3 when N is varied in increments of 30° over the range N=0 to 360°. To facilitate relative comparison, the values in Table I are shown as indexed relative to a value of 1 for the area of the triangular region Ar4 corresponding to a wrap angle of 30° as shown in FIG. 9. Wound pitch P20 was one-half of ribbon width W20.

TABLE 1

| | 0 | 30 | 60 | 90 | 120 | 150 | 180 | 210 | 240 | 270 | 300 | 330 | 360 |
|---|---|---|---|---|---|---|---|---|---|---|---|---|---|
| Region Ar3 | 27 | 27.5 | 29 | 32 | 34 | 35.5 | 36 | 37 | 40 | 45 | 51 | 57 | 63 |
| Region Ar2 | 9 | 9 | 9 | 9 | 10 | 13 | 18 | 23.5 | 28 | 32 | 35 | 39.5 | 45 |
| Difference in area | 18 | 18.5 | 20 | 23 | 24 | 22.5 | 18 | 13.5 | 12 | 13 | 16 | 17.5 | 18 |

From TABLE 1, it can be understood that whereas the difference in area was 18 for conventional manufacturing in which the wrap angle of parallel portion 20a was 360°, the difference in area was less than 18, producing a reduction in circumferential mass unbalance, in the range N=210 to 300. It is more preferred that this be within the range N=210 to 270, and most preferred that this be within the range N=240-10. The reason for this is that the point at which the difference in area reaches a minimum is believed to be within these ranges.

The foregoing numeric ranges are preferred because they permit reduction in the circumferential mass unbalance. Moreover, it is preferred that parallel portion 20a at first side WD1 in the tire width direction extend from 0° to N ° in terms of its location on the tire circumference, and that parallel portion 20a at second side WD2 in the tire width direction extend from (360−N °) to 360° in terms of its location on the tire circumference. Maintenance of such a positional relationship will make it possible to reduce couple unbalance.

Methods in which winding is carried out so as to cause parallel portion 20a to have a wrap angle of N ° (N=210 to 300) as described above may also be suitably used as methods for winding cap rubber 12 shown in FIG. 5. FIG. 5 shows in conceptual fashion the locus of the motion of the position at which winding of ribbon rubber 20 is carried out during an operation in which cap rubber 12 is formed. As shown in same drawing, ribbon rubber 20 is wound from start point S1 located at central location CL in the tire width direction until it arrives at end 12a at first side WD1 in the tire width direction, and then reverses direction at end 12a at first side WD1 in the tire width direction until it arrives at end 12b at second side WD2 in the tire width direction, and then reverses direction at end 12b at second side WD2 in the tire width direction until it arrives at finish point E1 located at central location CL in the tire width direction. In such case, as shown in FIG. 10, ribbon rubber 20 experiences a transition from inclined portion 20b to parallel portion 20a in the region at which reversal of direction occurs at first side WD1) in the tire width direction, following which there is another transition back to inclined portion 20b. Besides cap rubber 12, it is possible to employ the winding technique shown in FIG. 5 to base rubber 11.

Whereas in the present embodiment, to reduce couple unbalance, parallel portion 20a at first side WD1 in the tire width direction was made to extend from 0° to N ° in terms of its location on the tire circumference, and parallel portion 20a at second side WD2 in the tire width direction was made to extend from (360−N °) to 360° in terms of its location on the tire circumference, it is possible to deviate somewhat therefrom if some couple unbalance can be tolerated.

As described above, a pneumatic tire in accordance with the present embodiment having a rubber member 12 formed by winding a ribbon rubber 20 in uninterrupted fashion about a rotational axis of the tire. The robber member 12 has a parallel portion 20a at which the ribbon rubber 20 is parallel to a tire circumferential direction CD at an end toward an exterior in a tire width direction, and an inclined portion 20b at which the ribbon rubber 20 is inclined with respect to the tire circumferential direction CD in such fashion as to cause the ribbon rubber 20 to be directed from the parallel portion 20a toward an interior in the tire width direction. The ribbon rubber 20 from which the parallel portion 20a is formed is wound in the tire circumferential direction CD for a wrap angle of not 360° but N ° (N=210 to 300).

A method for manufacturing a pneumatic tire in accordance with the present embodiment, the method having an operation in which a rubber member 12 is formed by winding a ribbon rubber 20 in uninterrupted fashion about a rotational axis of the tire. At the operation in which the rubber member 12 is formed, a parallel portion 20a at which the ribbon rubber 20 is parallel to a tire circumferential direction CD at an end toward an exterior in a tire width direction, and an inclined portion 20b at which the ribbon rubber 20 is inclined with respect to the tire circumferential direction CD in such fashion as to cause the ribbon rubber 20 to be directed from the parallel portion 20a toward an interior in the tire width direction, are formed. The ribbon rubber 20 from which the parallel portion 20a is formed is wound in the tire circumferential direction CD for a wrap angle of not 360° but N ° (N=210 to 300).

In forming parallel portion 20a, by thus causing ribbon rubber 20 to be wound for a wrap angle of not 360° but N ° (N=210 to 300) in the tire circumferential direction, it is possible to reduce circumferential mass unbalance as compared with the conventional situation in which the wrap angle of the ribbon rubber thereat is 360°.

In accordance with the present embodiment, the parallel portion 20a is one of two parallel portions 20a, and the inclined portion 20b is one of two inclined portions 20b, one of each of which is respectively provided at either end at both a first side WD1 in the tire width direction and a second side WD2 in the tire width direction of the rubber member 12. The parallel portion 20a at the first side WD1 in the tire width direction extends from 0° to N ° in terms of the location thereof on the tire circumference. The parallel portion 20a at the second side WD2 in the tire width direction extends from (360−N °) to 360° in terms of the location thereof on the tire circumference.

Such an arrangement will make it possible to reduce couple unbalance.

In accordance with the present embodiment, the ribbon rubber 20 is wound from a start point S1 located at an end 5a at a first side WD1 in the tire width direction, toward a second side WD2 in the tire width direction, to reach a finish point E1 located at an end 5b at a second side WD2 in the tire width direction.

With such a locus of winding as well, it will be possible to reduce mass imbalance.

In accordance with the present embodiment, the ribbon rubber 20 is wound from a start point S1 located at a central location CL in the tire width direction until it arrives at an end 12a at a first side WD1 in the tire width direction, and then reverses direction at the end 12a at the first side WD1 in the tire width direction until it arrives at an end 12b at a second side WD2 in the tire width direction, and then reverses direction at the end 12b at the second side WD2 in the tire width direction until it arrives at a finish point E1 located at the central location CL in the tire width direction.

With such a locus of winding as well, it will be possible to reduce mass unbalance.

Structure employed at any of the foregoing embodiment(s) may be employed as desired at any other embodiment(s). The specific constitution of the various components is not limited only to the foregoing embodiment(s) but admits of any number of variations without departing from the gist of the present disclosure.

1. A pneumatic tire comprising:
a rubber member formed by winding a ribbon rubber in uninterrupted fashion about a rotational axis of the tire;
wherein the rubber member has a parallel portion at which the ribbon rubber is parallel to a tire circumferential direction at an end toward an exterior in a tire width direction, and an inclined portion at which the ribbon rubber is inclined with respect to the tire circumferential direction in such fashion as to cause the ribbon rubber to be directed from the parallel portion toward an interior in the tire width direction; and
wherein the ribbon rubber from which the parallel portion is formed is wound in the tire circumferential direction for a wrap angle of not 360° but N ° (N=210 to 300).

2. The pneumatic tire according to claim 1 wherein
the parallel portion is one of two parallel portions, and the inclined portion is one of two inclined portions, one of each of which is respectively provided at either end at both a first side in the tire width direction and a second side in the tire width direction of the rubber member;
the parallel portion at the first side in the tire width direction extends from 0° to N ° in terms of the location thereof on the tire circumference; and
the parallel portion at the second side in the tire width direction extends from (360−N °) to 360° in terms of the location thereof on the tire circumference.

3. The pneumatic tire according to claim 1 wherein the ribbon rubber is wound from a start point located at an end at a first side in the tire width direction, toward a second side in the tire width direction, to reach a finish point located at an end at a second side in the tire width direction.

4. The pneumatic tire according to claim 1 wherein the ribbon rubber is wound from a start point located at a central location in the tire width direction until it arrives at an end at a first side in the tire width direction, and then reverses direction at the end at the first side in the tire width direction until it arrives at an end at a second side in the tire width direction, and then reverses direction at the end at the second side in the tire width direction until it arrives at a finish point located at the central location in the tire width direction.

5. The pneumatic tire according to claim 1 wherein the rubber member is at least one member selected from among inner liner rubber, cap rubber, base rubber, sidewall rubber, and rim strip rubber.

6. A method for manufacturing a pneumatic tire, the method comprising:
an operation in which a rubber member is formed by winding a ribbon rubber in uninterrupted fashion about a rotational axis of the tire;
wherein, at the operation in which the rubber member is formed, a parallel portion at which the ribbon rubber is parallel to a tire circumferential direction at an end toward an exterior in a tire width direction, and an inclined portion at which the ribbon rubber is inclined with respect to the tire circumferential direction in such fashion as to cause the ribbon rubber to be directed from the parallel portion toward an interior in the tire width direction, are formed; and
wherein the ribbon rubber from which the parallel portion is formed is wound in the tire circumnferential direction for a wrap angle of not 360° but N ° (N=210 to 300).

7. The pneumatic tire manufacturing method according to claim 6 wherein
the parallel portion is one of two parallel portions, and the inclined portion is one of two inclined portions, one of each of which is respectively provided at either end at both a first side in the tire width direction and a second side in the tire width direction of the rubber member;
the parallel portion at the first side in the tire width direction extends from 0° to N ° in terms of the location thereof on the tire circumference; and
the parallel portion at the second side in the tire width direction extends from (360−N °) to 360° in terms of the location thereof on the tire circumference.

8. The pneumatic tire manufacturing method according to claim 6 wherein the ribbon rubber is wound so as to proceed from a start point located at an end at a first side in the tire width direction, toward a second side in the tire width direction, to reach a finish point located at an end at a second side in the tire width direction.

9. The pneumatic tire manufacturing method according to claim 6 wherein the ribbon rubber is wound so as to proceed from a start point located at a central location in the tire width direction until it arrives at an end at a first side in the tire width direction, and then reverse direction at the end at the first side in the tire width direction until it arrives at an end at a second side in the tire width direction, and then reverse direction at the end at the second side in the tire width direction until it arrives at a finish point located at the central location in the tire width direction.

10. The pneumatic tire manufacturing method according to claim 6 wherein the rubber member is at least one member selected from among inner liner rubber, cap rubber, base rubber, sidewall rubber, and rim strip rubber.
